(19) United States
(12) Patent Application Publication
(10) Pub. No.: US 2010/0193742 A1
(43) Pub. Date: Aug. 5, 2010

(54) POWER GENERATION PROCESS AND SYSTEM

(75) Inventor: Martin Oettinger, Queensland (AU)

Correspondence Address: NIXON PEABODY, LLP, 401 9TH STREET, NW, SUITE 900, WASHINGTON, DC, 20004-2128, US

(73) Assignee: ZEROGEN PTY LTD., Milton, Queensland (AU)

(21) Appl. No.: 12/670,668

(22) PCT Filed: Jul. 31, 2008
(86) PCT No.: PCT/AU08/01101

§ 371 Date: Feb. 16, 2010

(30) Foreign Application Priority Data
Aug. 1, 2007 (AU) 2007904133

(51) Int. Cl. C01B 3/34; B01J 19/00

(52) U.S. Cl. 252/373; 422/187

(57) ABSTRACT

The present invention is concerned with a power generation process and system (10) comprising gasifying (12) a carbonaceous fuel source to yield a synthesis gas (17); cooling the synthesis gas; removing carbon dioxide from die cooled synthesis gas (18), leaving a combustible gas suitable (19) for power generation; compressing (20) the removed carbon dioxide for storage or sequestration; and utilising at least some of the compressed carbon dioxide for the cooling step. A system for implementing the above process, including a suitable valve arrangement, is also provided.

### FIELD OF THE INVENTION

The invention relates to a process and system for generating electrical power. More particularly the present invention relates a process and system for improving the operation of gasification-based power stations with carbon dioxide capture and associated sequestration.

### BACKGROUND OF THE INVENTION

In this specification, where a document, act or item of knowledge is referred to or discussed, this reference or discussion is not an admission that the document, act or item of knowledge or any combination thereof was at the priority date:
(i) part of common general knowledge; or
(ii) known to be relevant to an attempt to solve any problem with which this specification is concerned.

A substantial portion of the energy needs of both industrialised and developing countries will continue to be provided by coal-fired power stations for the foreseeable future. However, burning fossil-fuels such as coal releases large volumes of carbon dioxide (CO₂) into the atmosphere, which is now known to contribute to potentially catastrophic global warming. There is accordingly a clear need to develop technologies that facilitate the continued use of coal as a fuel source, but also reduce the volume of atmospheric CO₂ emissions.

Carbon dioxide capture and storage is an example of such technology, where the CO₂ produced in coal-fired power stations is captured, compressed and then stored, instead of being released into the atmosphere. Subterranean geological formations have been suggested as suitable storage sites for captured CO₂, in a practice known as ‘geosequestration’.

Gasification-based power stations facilitate the capture of CO₂ from a carbonaceous fuel source before the fuel source is combusted to generate power. The captured CO₂ may then be conveniently transported to a geosequestration site. As known to those skilled in the art, coal gasification involves reacting coal or other carbonaceous fuel sources, an oxidant (such as air or oxygen), and steam under high pressure and temperature to yield a synthesis gas (syngas) comprising primarily of hydrogen and carbon monoxide (CO). The syngas is cooled (or quenched) and cleaned of any unwanted materials such as ash, and then reacted in a water-gas shift reaction to convert the CO into CO₂, said reaction also producing additional hydrogen.

The CO₂ is captured from the syngas stream of the gasifier unit and then compressed to a supercritical fluid for later geosequestration. The remaining hydrogen-rich gas can be combusted to power a gas turbine for electricity generation or used to provide fuel for a fuel cell. In a combined-cycle power plant, waste heat from the gas turbine is also used to make steam to generate additional electricity via a steam turbine. Combined-cycle plants that utilise syngas as a fuel source for the gas turbine are known as integrated gasification combined cycle (IGCC) plants.

Gasification-based power plants with CO₂ capture and sequestration are known, and various means for optimising the power-generation processes practised therein are described in the patent literature. For example, U.S. Pat. No. 5,724,805 describes a gasification-based power plant where captured CO₂ is recycled to improve the efficiency of the gas turbine. U.S. Pat. No. 6,333,015 describes a gasification-based power plant, in which recycled CO₂ is utilised to improve the gasification reaction. In particular, primary and secondary gasifiers are described, with syngas produced in the primary gasifier being further reacted in the secondary reactor in the presence of a carbon source (such as a coke bed) and CO₂. The syngas thus produced in the secondary gasifier is then used to power a gas turbine (as in conventional processes), with CO₂ extracted from turbine exhaust gases being recycled back into the secondary gasifer.

U.S. Pat. No. 5,265,410 describes separation of CO₂ from the gas turbine exhaust, to be recirculated to a combustor, in order to adjust and maintain the temperature of gases combusted therein. Further, U.S. Pat. No. 6,877,322 describes a power plant employing a ‘hybrid’ gasification cycle, in which compressed exhaust gas from the steam generator is recycled back to the gasifier to control its internal temperature and assist the gasification reaction.

As noted above, the syngas produced in the gasifier is quenched prior to contamination removal, water-shift and CO₂ separation. Typically, quenching occurs within a quenching chamber of the gasifier, wherein the sensible heat of the hot syngas is used to vaporise water. In the power station process described in Patent Application WO 03/080503, water is recycled from elsewhere in the power-generation process for use as the quench fluid.

Syngas may be partially quenched (cooled to a temperature of around 900° C.) or fully quenched (cooled to a temperature of around 200° C.).

Syngas quenching may also be effected by the use of recycled, previously-quenched syngas. However, recycled-syngas quenching necessitates the use of a dedicated syngas compressor, thereby reducing the efficiency of the overall power generation process.

Accordingly, it would be advantageous to develop an improved gasification-based, power-generation process that allows for syngas quenching.

### SUMMARY OF THE INVENTION

According to a first aspect of the present invention there is provided a power generation process comprising:
gasifying a carbonaceous fuel source to yield a synthesis gas;
cooling the synthesis gas;
removing carbon dioxide from the cooled synthesis gas, leaving a combustible gas suitable for power generation;
compressing the removed carbon dioxide for storage or sequestration; and
utilising at least some of the compressed carbon dioxide for the cooling step.

In essence, the process of the invention uses high pressure carbon dioxide either in isolation or in combination with cooled syngas from a gasifier to provide a quench of the extremely hot syngas exiting the gasifier, optionally also in combination with water-based fluids such as an atomised spray.

The process of the present invention obviates the need to provide a dedicated quench fluid compressor for recycling syngas for quenching purposes. Instead, the invention takes advantage of a source of already compressed fluid, in the form of carbon dioxide, that is compressed before conveyance to a sequestration site, and redeploys the compressed carbon dioxide in an industrially beneficial way.

Optionally, the process includes the steps of:
combining the compressed carbon dioxide with a diverted stream of the cooled synthesis gas, to increase the pressure thereof; and
utilising the compressed synthesis gas and carbon dioxide during the cooling step.

According to this embodiment of the invention, the recycled carbon dioxide effectively acts in place of a cooled combustible gas compressor, thereby enabling a gas recycle quench without the need for a dedicated syngas compressor.

The pressure of the carbon dioxide must be sufficiently high to provide a combined syngas/carbon dioxide quench stream at a rate which is not substantially more than is required to quench the syngas. Conveniently, the pressure of carbon dioxide when in the form of a supercritical fluid, such as is found in a sequestration pipeline, is suitably high to be combined with cooled syngas and utilised as a quench fluid.

Preferably, the combining step comprises educting the cooled combustible gas with the compressed carbon dioxide.

According to a second embodiment of the present invention, there is provided a power generation system, comprising:
a gasifier, for gasifying a carbonaceous fuel source to yield a synthesis gas;
means for cooling the synthesis gas;
means for removing carbon dioxide from the cooled synthesis gas, to leave a combustible gas suitable for power generation;
a compressor, for compressing the removed carbon dioxide for storage or sequestration; and
means for redirecting at least some of the compressed carbon dioxide towards the cooling means, to be utilised to cool the synthesis gas.

Preferably, the power generation system includes:
a power plant;
a transport pipeline system for transporting compressed carbon dioxide for storage or sequestration; and
valve means, adapted to retain a volume of compressed carbon dioxide in the transport pipeline system upon shutdown of the power plant, said retained carbon dioxide being accessible for use as a quenching fluid during a start-up of the power plant.

The transport pipeline system may include appropriate storage means such as buffer storage.

This preferred form of the present invention can assist in ameliorating startup and/or shutdown issues associated with a gasification-based power plant using a syngas quench, with or without assisted water atomisation,

Optionally, the power generation system includes an eductor, interposed between the cooling means and the compressor, the eductor being configured to entrain cooled syngas into the means for redirecting compressed carbon dioxide towards the cooling means.

According to a preferred embodiment, the system includes a combined-cycle power plant for generating power from the combustible gas.

### BRIEF DESCRIPTION OF THE DRAWINGS

Embodiments of the present invention will now be further explained and illustrated by reference to the accompanying drawings, in which:

FIG. 1 is a flow diagram illustrating a first embodiment of the present invention performed within a gasification-based power plant with carbon dioxide capture and associated sequestration; and

FIG. 2 is a flow diagram illustrating a second embodiment of the present invention performed within a gasification-based power plant with carbon dioxide capture and associated sequestration.

### DETAILED DESCRIPTION OF THE DRAWINGS

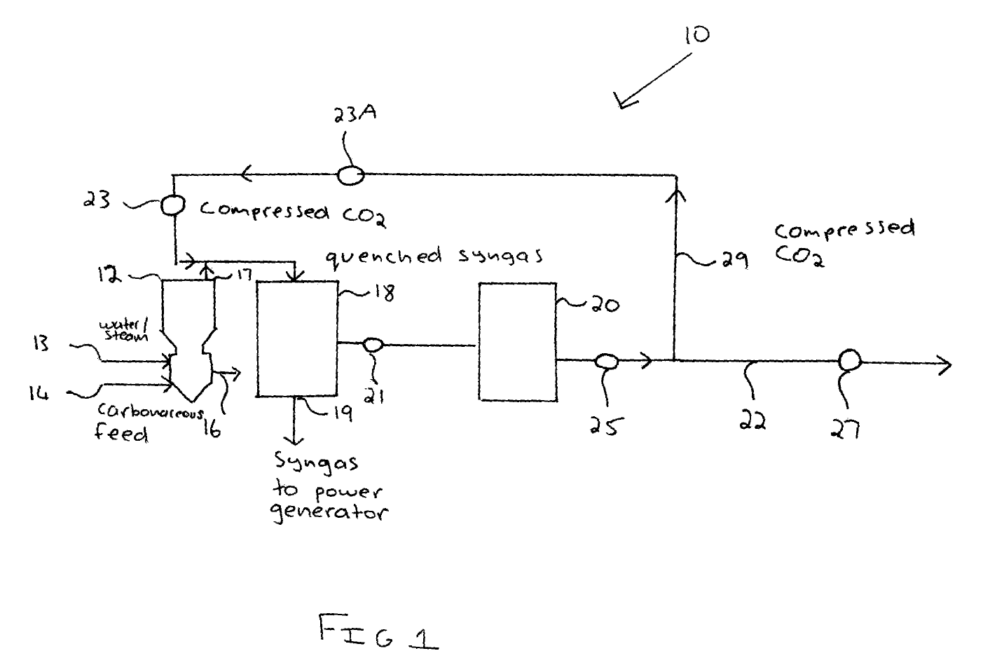

Turning to FIG. 1, an integrated gasification combined cycle (IGCC) power plant 10 with CO₂ capture and associated geosequestration is illustrated. The plant 10 is suitable for baseload electricity generation

The plant 10 includes an entrained flow gasifier 12, a syngas treatment and CO₂ removal chamber 18, CO₂ compressor 20 and a compressed CO₂ transmission pipeline 22. Isolation valves 21, 23, 23A, 25 & 27 are interposed between a number of these components, the function of which is described in greater detail below.

In an example considered, the transmission pipeline 22 is 220 km in length and carries compressed CO₂ to Queensland's northern Denison Trough region. This region has been identified by the. Australian Government as having suitable structures for the storage of compressed CO₂. Significantly, the area contains natural gas deposits that already have relatively high levels of naturally occurring CO₂. Moreover, the region is also seismically stable.

Using a series of wells and distribution pipelines (not shown), the CO₂ is injected up to 2 km below the surface into saline aquifers for permanent sequestration.

The skilled reader will also appreciate that pipeline 22 may not lead directly to a sequestration site, and intermediate storage and transport of the compressed CO₂ could be employed For example, the pipeline system may include suitable buffer storage means, or may connect to another storage means, such as a marine, rail or road tanker for further transport of compressed CO₂ towards an ultimate sequestration site destination.

As will be well understood by those skilled in the art, the plant 10 also includes supporting infrastructure, such as apparatus for coal handling, gas metering, fire detection, waste management etc., as well as relevant building infrastructure, such as a control room, laboratory, workshop, warehouse, etc.

The gasifier 12 is fed with a carbonaceous fuel source through a supply line 14. Subsequent to gasification of the fuel source (see below), slag is removed from the gasifier through an outlet 16.

The carbonaceous fuel source for the entrained-flow gasifier 12 is typically coal in a powdered form that has been produced in a coal mill (not shown). The fuel source is reacted in the gasifer 12 under high pressure, in the presence of oxygen and steam (delivered through supply fine 13) to create a synthesis gas (or ‘syngas’) primarily composed of hydrogen gas and carbon monoxide. CO₂ is also present in the syngas, but generally in significantly lower quantities.

At the outlet 17 of the gasifier 12, the temperature of the syngas is around 1500° C., which results in mineral matter being present in the syngas as a liquid or sticky substance. In order to protect downstream equipment from fouling caused by deposit of this liquid or sticky slag on equipment surfaces, the syngas must be cooled (or ‘quenched’) to a temperature of around 800° C. to 900° C. (for a partial quench) or, in some circumstances, to as low as 200° C.

The quenched syngas is delivered into the syngas treatment and CO, removal system 18, where is it first cleaned of unwanted material such as fly ash, sulphur-containing compounds, and nitrogen-containing compounds.

The cooled and cleaned syngas then undergoes a water-gas shift reaction, involving the addition of water and a suitable catalyst. The effect of the shift reaction is to transfer the heating value of the carbon monoxide to the hydrogen gas, with the conversion of carbon monoxide into CO₂. Additional hydrogen is also produced through the water-gas shift reaction.

Next, the CO₂ is separated out of the syngas. CO₂ separation may be effected by performing the Selexol® process, in which Selexol solvent dissolves the CO₂ from the syngas at relatively high pressure (typically 2.07 to 6.89 MPa). The CO₂-rich solvent is then reduced in pressure and/or steam-stripped, in order to release and recover the CO₂, with the hydrogen being recovered as a separate stream.

Alternative or additional CO₂ separation techniques may be implemented in the CO₂ removal system 18, including those utilising:
alternative physical solvents, such as Genosorb®;
amine-based, chemical solvents, such as Monoethanolamine (MEA), Diethanolamine (DEA) or Methyldiethanolamine (MDEA); or
combined physical/chemical solvents, such as Sulfinol®.

Subsequent to separation, high-hydrogen syngas exits the CO₂ removal system 18 through an outlet 19, and is directed to a combined cycle power plant, to be combusted in a gas turbine (not shown) for power generation or to a fuel cell for power generation. It will be noted that only small quantities of CO₂ are released into the atmosphere during combustion of high-hydrogen syngas, in comparison with combustion of a carbonaceous fuel source, such as coal.

Moreover, as understood by those skilled in the art, an IGCC plant may also include apparatus (not shown) for recovering heat from exhaust gases exiting the gas turbine, said heat being used to produce steam in order to generate additional power by way of a steam turbine. A combined cycle plant is more energy efficient than an open cycle plant (i.e. one without waste-heat recovery for powering steam turbines) and produces more power per unit of CO₂ emissions.

It is estimated that the process of gasification, water-shift and CO₂ separation is capable of converting and recovering a total of about 70% to 95% of the carbon from the coal as separated and sequestered CO₂.

The separated CO₂ exits the separation system 18 through an outlet and is directed to a compressor 20 in which it is compressed to a supercritical fluid.

Subsequent to compression, the CO₂ is transported along a transmission pipeline 22 to the sequestration site, to be injected into a selected geological formation for long term sequestration.

A part of the stream of output compressed CO₂ is directed by way of pipeline 29 towards the outlet 17 of the gasifier 12. In this way, compressed CO₂ can be utilised as a quench fluid for the hot syngas exiting the gasifier 17. The high heat carrying capacity of CO₂ makes for a particularly effective quench, allowing the volume of water required to effect a quench to be substantially reduced. The volume of compressed CO₂ used as a quench fluid may be controlled through selective adjustment of control valves 23, 23A.

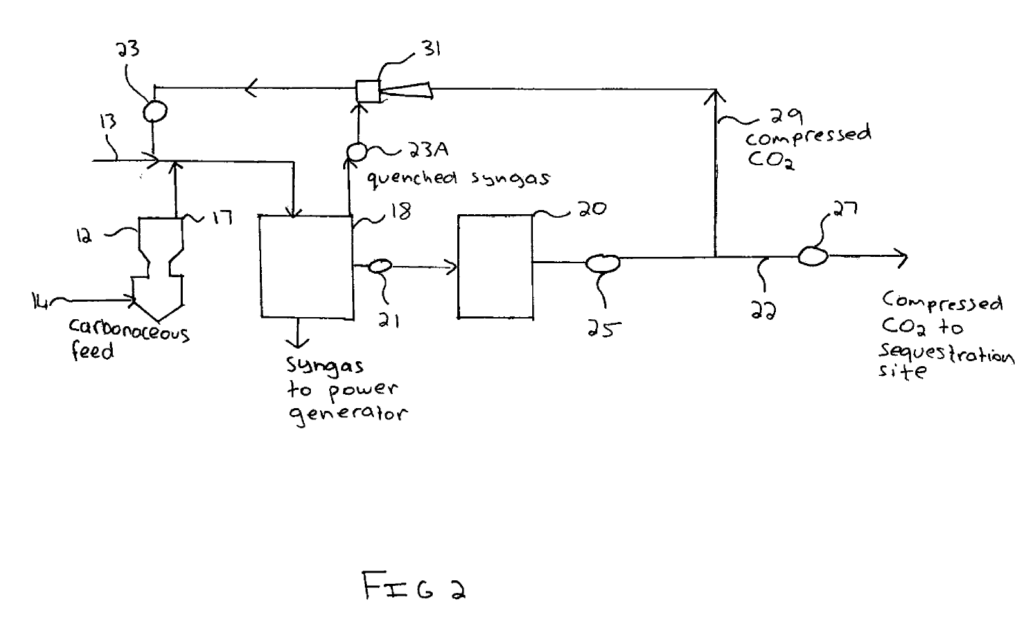

Turning now to FIG. 2, an alternative embodiment of the present invention is illustrated. This embodiment differs from the embodiment illustrated in FIG. 1 in that a portion of the stream of cooled syngas exiting the CO₂ removal system 18 (and otherwise bound for the IGCC power plant) is directed towards a venturi-type eductor 31 located in the pipeline 29 conducting compressed CO₂ from the compressor 20 back to the gasifier output 17.

The eductor 31 utilises the high pressure CO₂ to entrain a stream of cooled syngas into the gasifier output 17, and thereby create a combined syngas/CO₂ quench fluid for hot syngas exiting the gasifier 12.

The compressed CO₂ has the effect of raising the pressure (and consequently the net mass-flow) of the syngas, without the need for a dedicated syngas compressor, resulting in an even more energy efficient quench in comparison to conventional methods.

During normal operation of the power plant 10, each of the isolation valves 21, 23, 23A, 25 and 27 are open, to allow for the free flow of quenched syngas, hydrogen gas and compressed CO₂ amongst the functional units of the power plant. On shutdown of the plant, the isolation valves 21, 23, 23A, 25 27 are closed. This results in a large quantity of compressed CO₂ remaining in the transport pipeline 22 system downstream of valve 27. Then, upon startup of the plant 10, valves 23 and 27 are opened, enabling this compressed CO₂ within the system to be utilised during startup, with or as an alternative to water.

Use of high pressure CO₂ (in isolation or in combination with recycled cooled syngas) during startup reduces risks associated with use of water alone during startup of the plant. These risks include equipment damage to components such as the gasifer 12, gasifier outlet line 17 and syngas cleanup system 18 due to liquid water contacting the surfaces of those component.

During shutdown, the use of high pressure CO₂ (isolation or in combination with recycled cooled syngas) can reduce similar risks associated with use of water.

The compressed CO₂ may also be used as a source of motive gas for transporting the powdered, carbonaceous fuel source along pipeline 14 to the gasifier.

Modifications and improvements to the invention will be readily apparent to those skilled in the art. Such modifications and improvements are intended to be within the scope of this invention.

The word ‘comprising’ and forms of the word ‘comprising’ as used in this description and in the claims do not limit the invention claimed to exclude any variants or additions.

Modifications and improvements to the invention will be readily apparent to those skilled in the art. Such modifications and improvements are intended to be within the scope of this invention.

1. A power generation and carbon dioxide sequestration process comprising:
gasifying a carbonaceous fuel source to yield a synthesis gas;
cooling the synthesis gas;
removing carbon dioxide from the cooled synthesis gas, leaving a combustible gas suitable for power generation;
compressing the removed carbon dioxide for transportation to a sequestration site;
transporting the compressed carbon dioxide to a sequestration site;
sequestering the compressed carbon dioxide;
wherein, prior to its sequestration at least some of the compressed carbon dioxide is utilised in the cooling step.

2. A power generation process according to claim 1, wherein the compressed carbon dioxide utilised in the cooling step is in the form of a supercritical fluid.

3. A power generation process according to claim 1 further including the step of controlling the volume of compressed carbon dioxide utilised in the cooling step.

4. A power generation process according to claim 3 wherein the volume of compressed carbon dioxide utilised in the cooling step is controlled through the use of a valve arrangement.

5. A power generation process according to claim 1 further including the steps of combining the compressed carbon dioxide with a second fluid so as to increase the pressure and net-mass flow thereof, and utilising the combined compressed carbon dioxide and second fluid in the cooling step.

6. A power generation process according to claim 5 wherein the second fluid is a diverted stream of previously cooled synthesis gas.

7. A power generation process according to claim 6 wherein the combining step comprises educting the second fluid with compressed carbon dioxide so as to entrain a steam of second fluid for use in the cooling step.

8. A power generation process according to claim 1 wherein the removing step involves performing the Selexol® process.

9. A power generation process according to claim 1 wherein the removing step involves utilising any one or more of: a physical solvent; an amine-based chemical solvent; a combined physical/chemical solvent.

10. A power generation and carbon dioxide sequestration system, comprising:
a gasifier, for gasifying a carbonaceous fuel source to yield a synthesis gas;
means for cooling the synthesis gas;
means for removing carbon dioxide from the cooled synthesis gas, to leave a combustible gas suitable for power generation;
a compressor, for compressing the removed carbon dioxide for transportation to a sequestration site;
a transport pipeline system for transporting the compressed carbon dioxide to a sequestration site;
means for sequestering the carbon dioxide; and
means for redirecting at least some of the compressed carbon dioxide towards the cooling means prior to its sequestration, to be utilised to cool the synthesis gas.

11. A power generation system according to claim 10 further including means for combining the compressed carbon dioxide with a second fluid so as to increase the pressure and net-mass flow thereof, prior to redirecting the compressed carbon dioxide towards the cooling means, to be utilised to cool the synthesis gas.

12. A power generation system according to claim 10 wherein the second fluid is a diverted stream of previously cooled synthesis gas.

13. A power generation system according to claim 11 wherein the combining means includes an eductor interposed between the cooling means and the compressor, the eductor being configured to educt second fluid with compressed carbon dioxide so as to entrain a stream of second fluid and compressed carbon dioxide towards the cooling means.

14. A power generation system according to claim 10, wherein the means for removing carbon dioxide from the cooled synthesis gas includes means for performing the Selexol® process.

15. A power generation system according to claim 10, further including:
a power plant; and
valve means, adapted to retain a volume of compressed carbon dioxide in the transport pipeline system upon shutdown of the power plant, said retained carbon dioxide being accessible for use as a quenching fluid during a start-up of the power plant.
